(19) United States
(12) Patent Application Publication
(10) Pub. No.: US 2025/0368295 A1
(43) Pub. Date: Dec. 4, 2025

(54) BICYCLE BOTTOM BRACKET ASSEMBLY

(71) Applicant: Porsche eBike Performance GmbH, Ottobrunn (DE)

(72) Inventor: Marc KLUGE, Besigheim (DE)

(73) Assignee: Porsche eBike Performance GmbH, Ottobrunn (DE)

(21) Appl. No.: 18/872,821

(22) PCT Filed: Jun. 23, 2023
(86) PCT No.: PCT/EP2023/067112

§ 371 Date: Dec. 7, 2024

(30) Foreign Application Priority Data
Jun. 27, 2022 (DE) 10 2022 115 941.8

(51) Int. Cl. B62M 6/55; B62M 6/50

(52) U.S. Cl. CPC B62M 6/55; B62M 6/50

(57) ABSTRACT

A bicycle bottom bracket arrangement (10) has a bottom bracket shaft (21) and at least one pedal crank (24) connected in a rotationally secure manner to the bottom bracket shaft (21). The bicycle bottom bracket arrangement (10) also has a torque sensor (30) with a torsion shaft (32) that is driven by the bottom bracket shaft (21) at an introduction location (E) of the torque sensor (30). An output shaft (40) is driven by the torsion shaft (32) at an output location (A) that is remote from the introduction location (E). A reference arm (39) is fixed at the introduction location (E) and has an indicator (38) that refers to a reference scale (66; 66′) associated with the torsion shaft at the output location (A) in a rotationally secure manner. A stationary electric torsion sensor detects the position of the reference indicator (38) in relation to the reference scale.

### FIELD OF THE INVENTION

The invention relates to a bicycle bottom bracket arrangement having a torque sensor arrangement for detecting the torque that is introduced by the rider into the bottom bracket arrangement.

### BACKGROUND OF THE INVENTION

A bicycle bottom bracket arrangement having a torque sensor arrangement is used particularly in so-called pedelecs, that is to say, in bicycles that have an electric drive motor that works in a supporting manner with respect to the human torque that is introduced by the rider. In this case, the degree of support by the electric drive motor is controlled and regulated inter alia in a manner dependent on the human torque that is introduced by the rider.

Torque sensor arrangements are known from U.S. Pat. No. 8,646,560, U.S. Pat. No. 9,221,516, U.S. Pat. No. 10,399,636 and EP 3 556 644 B1. DE 20 2007 019 291 U1 discloses a torque sensor arrangement having a magnetized hollow torsion shaft, the torque-dependent magnetic field of which is detected by a stationary magnetic field sensor. Such a torque sensor arrangement is demanding and complex to produce.

Accordingly, an object of the invention is to provide a simple and cheap-to-produce bicycle bottom bracket arrangement having a torque sensor arrangement.

### SUMMARY OF THE INVENTION

The bicycle bottom bracket arrangement according to the invention has a torque sensor arrangement with a bottom bracket shaft arrangement having a bottom bracket shaft. The bottom bracket shaft is the shaft in which the rider introduces a torque via one or two pedal cranks into the bottom bracket arrangement. The pedal cranks or the two pedal cranks are connected to the bottom bracket shaft in a rotationally secure manner. The bottom bracket shaft drives a torsion shaft at an axial torsion shaft introduction location. The torsion shaft may in principle be configured to be identical to the bottom bracket shaft or may be configured integrally therewith, but is preferably configured separately from the bottom bracket shaft.

Furthermore, the bottom bracket arrangement has an output shaft that is driven by the torsion shaft at an axial torsion shaft output location, which is axially remote from the torsion shaft introduction location. A reference arm has a reference indicator and is fixed to the torsion shaft in a rotationally secure manner at the torsion shaft introduction location. The reference indicator refers to a reference scale that is associated with the torsion shaft at the torsion shaft output location in a rotationally secure manner. The reference indicator therefore indicates on the reference scale the torsion of the torsion shaft between the axial human torque introduction location and the axial output location thereof.

An electric position sensor detects the position of the reference indicator in relation to the torsion shaft reference scale. In principle, the reference indicator, the reference scale and the position sensor can be physically configured so that, for example, a magnetic/inductive detection of the position of the reference indicator in relation to the reference scale is carried out.

The reference scale of some embodiments is in the form of an optically detectable reference scale and the position sensor is a digital camera. It is thereby possible to optically detect with simple and cheap means the torsion of the torsion shaft between the axial introduction location thereof and the axial output location thereof.

The reference scale may be fitted or configured on the torsion shaft in a radially detectable manner and for the reference scale to be radially detected together with the reference indicator by the position sensor or by the digital camera. The torsion sensor therefore looks in the radial direction toward the reference scale on the torsion shaft. Since the torsion of the torsion shaft can thereby be detected only temporarily during a complete revolution of the torsion shaft, a plurality of torsion sensors are particularly preferably provided over the circumference in order thereby to be able to constantly detect the torsion of the torsion shaft during the complete revolution of the torsion shaft.

There is alternatively provision for the reference scale to be configured on the torsion shaft in an axially detectable manner and to be axially detected together with the reference indicator by the position sensor. In this manner, the torsion of the torsion shaft can be detected virtually continuously during the complete revolution of the torsion shaft and particularly also in the stationary state in each rotational stationary position of the torsion shaft with a single torsion sensor or with a single digital camera.

The bottom bracket arrangement may have an output wheel that may be a chain ring, by which a front wheel or a rear wheel of a bicycle, for example, can be driven via a link chain or a toothed belt. The output wheel is driven by the torsion shaft. The output wheel may, in principle, be connected in a rotationally secure manner to the torsion shaft at the output location thereof. Alternatively, however, the output wheel is arranged on a separate output shaft which is driven at the output location by the torsion shaft via a gear mechanism.

Preferably, the bottom bracket arrangement has an electric drive motor that generates an electric drive torque in accordance with the signal of the position sensor and by which the output wheel is driven where necessary and in addition to the human torque.

The invention is explained in greater detail below with reference to the Figures.

### BRIEF DESCRIPTION OF THE DRAWINGS

FIG. 1 is a schematic illustration of a bicycle bottom bracket arrangement having a bottom bracket shaft, a separate torsion shaft and a separate output shaft and having two alternative torque sensor arrangements.

FIG. 2 is a radial view of the torsion shaft of the bicycle bottom bracket arrangement of FIG. 1 in a first exemplary embodiment with a position sensor digital camera arranged radially relative to the torsion shaft.

FIG. 3 is an axial view toward the torsion shaft of the bicycle bottom bracket arrangement of FIG. 1 in a second exemplary embodiment with a position sensor digital camera arranged axially relative to the torsion shaft.

### DETAILED DESCRIPTION

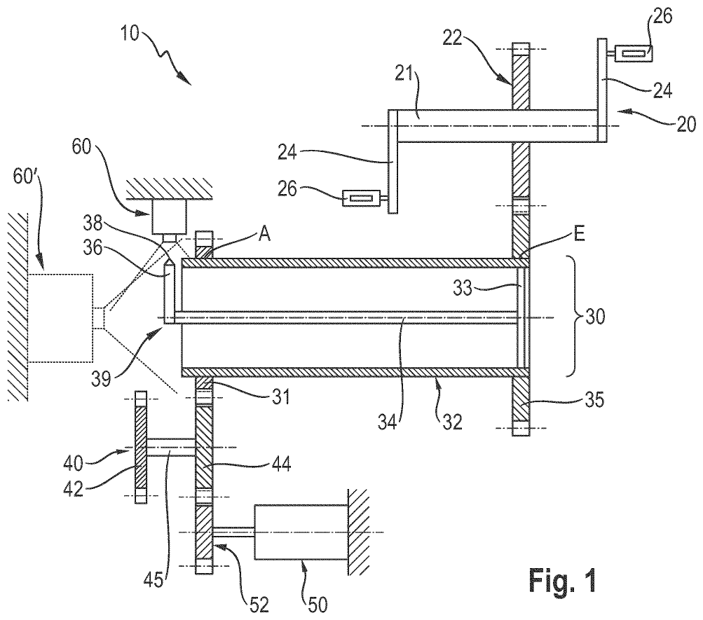

FIG. 1 illustrates a bicycle bottom bracket arrangement 10, which, in this instance, is in the form of a so-called mid-mounted bicycle motor for installation in an electric pedal bicycle.

The bicycle bottom bracket arrangement 10 has a bottom bracket shaft arrangement 20, a torque sensor arrangement 30 and an output arrangement 40 having an electric drive motor 50.

The bottom bracket shaft arrangement 20 comprises a bottom bracket shaft 21 that is supported rotatably about an axis. Pedal cranks 24 are connected in a rotationally secure manner at opposite ends of the bottom bracket shaft 21 and a pedal 26 is fit and retained at the external crank end of each pedal crank 24. A rider introduces a human torque into the bicycle bottom bracket arrangement 10 via the bottom bracket shaft arrangement 20. A toothed wheel 22 is connected to the bottom bracket shaft 21 in a rotationally secure manner.

The torque sensor arrangement 30 has a torsion shaft 32 in the form of a cylindrical hollow shaft. The torsion shaft 32 rotates about an axis X and has such dimensions that it has a substantial torsion over the axial length thereof with typical human torques in the order of magnitude of 100 Nm. A toothed wheel 35 is located externally on the torsion shaft 32 at an axial introduction location E in a rotationally secure manner and is driven by the bottom bracket shaft toothed wheel 22. An output toothed wheel 31 is provided at an axial output location at the other longitudinal end of the torsion shaft 32, and the human torque is transmitted from the output toothed wheel 31 to a summing toothed wheel 44 of the output arrangement 40. The introduction location E and the output location A are located axially as far apart as possible and have an axial spacing from each other of at least several centimeters.

The output arrangement 40 has a summing shaft 45 to which a summing toothed wheel 44 and, for example, an output wheel 42 in the form of a chain ring are connected in a rotationally secure manner. The electric drive motor 50 has a drive motor toothed wheel 52, via which the summing toothed wheel 44 is driven where necessary additionally with the drive motor torque.

A reference arm 39 is fixed inside the the torsion shaft 32 in a rotationally secure manner at the axial introduction location E, which constitutes a radial plane. The reference arm 39 has a radial arm 33 in the region of the introduction location E. The radial arm 33 retains an axial arm 34 that extends axially in the axis X and that is non-torsional. The free longitudinal end of the axial arm 34 retains, in a rotationally secure manner, a radially orientated indicator arm 38 which again has at the radially external end thereof a reference indicator 38 in the form of a cone tip.

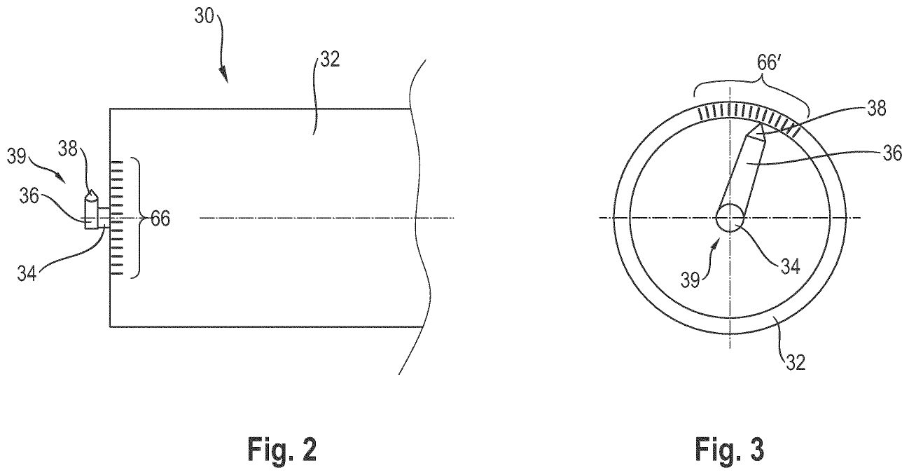

FIG. 2 illustrates a first exemplary embodiment of the torque sensor arrangement 30. The region of the output location A has a radially detectable optical reference scale 66 fit on the cylindrical externally circumferential face of the torsion shaft 32. The reference indicator 38 is located directly beside the reference scale 66, moves in the event of torsion of the torsion shaft 32 parallel with the reference scale 66 and indicates on the reference scale 66 the current torsion of the torsion shaft 32. The reference scale 66 and the reference indicator 38 are detected in a radial optical manner by an electric torsion sensor 60, which in this exemplary embodiment is in the form of a digital camera.

FIG. 3 illustrates a second exemplary embodiment of the torque sensor arrangement 30, in which an axially detectable reference scale 66′ is arranged on the annular end face of the torsion shaft 32 in the region of the output location A. The reference scale 66′ and the reference indicator 38 are axially optically detected in an uninterrupted manner by an electric torsion sensor 60, which is in the form of a digital camera.

It is thereby possible for the electric drive motor 50 to provide an additional supporting electromotive drive power in accordance with the human torque which is detected quantitatively by the torque sensor arrangement 30.

The torque sensor arrangement 30 further establishes the rotation direction of the established human torque and the speed of the torsion shaft 32.

1. A bicycle bottom bracket arrangement (10) having a torque sensor arrangement (30), the bottom bracket arrangement (10) comprising:
a bottom bracket shaft arrangement (20) having a bottom bracket shaft (21) and at least one pedal crank (24) connected to the bottom bracket shaft (21) in a rotationally secure manner;
a torsion shaft (32) that is driven by the bottom bracket shaft (21) at an axial introduction location (E) of the torque sensor arrangement (30);
an output shaft (40) that is driven by the torsion shaft (32) at an axial output location (A) it is axially remote from the introduction location (E);
a reference arm (39) that is fixed at the introduction location (E) has, the reference arm (39) having a reference indicator (38) which that refers to a reference scale (66; 66′) that is associated with the torsion shaft (32) at the output location (A) in a rotationally secure manner; and
a stationary, electric torsion sensor (60; 60′) that detects the position of the reference indicator (38) in relation to the reference scale (66; 66′).

2. The bicycle bottom bracket arrangement (10) of claim 1, wherein the torsion shaft (32) is a cylindrical hollow shaft.

3. The bicycle bottom bracket arrangement (10) of claim 1, wherein the torsion sensor (60; 60′) is a digital camera.

4. The bicycle bottom bracket arrangement (10) of claim 1, wherein the reference scale (66) is configured to be radially detectable and is detected radially by the torsion sensor (60) together with the reference indicator (38).

5. The bicycle bottom bracket arrangement (10) of claim 1, wherein the reference scale (66′) is configured to be axially detectable and is axially detected together with the reference indicator (38) by the position sensor (60′).

6. The bicycle bottom bracket arrangement (10) of claim 1, wherein the torsion shaft (32) is configured separately from the bottom bracket shaft (21).

7. The bicycle bottom bracket arrangement (10) of claim 1, further comprising an output wheel (42) that is driven by the torsion shaft (32).

8. The bicycle bottom bracket arrangement (10) of claim 1, further comprising an electric drive motor (50) that is selectively operable for providing additional driving force to an output wheel (42) that is driven by the torsion shaft (32).
